(19) United States
(12) Patent Application Publication
(10) Pub. No.: US 2004/0245395 A1
(43) Pub. Date: Dec. 9, 2004

(54) Aircraft ice protection system

(76) Inventor: Randall W. Wallace, Uniontown, OH (US)

Correspondence Address: Cynthia S. Murphy, Renner, Otto, Boisselle & Sklar, LLP, Nineteenth Floor, 1621 Euclid Avenue, Cleveland, OH, 44115-2191, US

(21) Appl. No.: 10/842,401

(22) Filed: May 10, 2004

Related U.S. Application Data
(60) Provisional application No. 60/469,375, filed on May 9, 2003.

(51) Int. Cl. B64D 15/00

(52) U.S. Cl. 244/134 R

(57) ABSTRACT

An ice-protection system comprising a heater element, an electrically and thermally insulating medium that at least partially surrounds the heater element, an ice-adhesion-reducing coating, and an outermost surface to which the coating is applied. The coating reduces the ice adhesion of the outermost surface by at least about 30% when compared to an uncoated version of the outermost surface.

### RELATED APPLICATION

This application claims priority under 35 U.S.C. §119(e) to U.S. Provisional Application No. 60/469,375 filed on May 9, 2003. The entire disclosure of this earlier application is hereby incorporated by reference.

### FIELD OF THE INVENTION

The present invention relates generally as indicated to an aircraft ice protection system and, more particularly, to an electrically heated ice protection system.

### BACKGROUND OF THE INVENTION

An aircraft periodically can be exposed to conditions of precipitation and low temperatures that can cause the formation of ice on its wings and other exposed surfaces. If the aircraft is to perform adequately during flight, it is important that the formation of ice be prevented or that any ice formed be removed, thereby causing ice protection systems to be routinely installed on aircraft. Of particular interest in the present invention is an electrically heated ice protection system, which typically comprises an ice-protection panel that is installed on the aircraft. For example, such an ice-protection panel can be secured to each of the aircraft's wings to prevent ice accumulation thereon.

An ice-protection panel typically will include an inner support layer, a heating layer, a thermal distribution layer, and an outer cover layer. The inner support layer is cemented or otherwise attached to the airfoil and is made of a material that provides electrical insulation between the heating layer and the airfoil (e.g., rubber coated fiberglass fabric). The heater layer incorporates a heating element and is made of a material that provides an appropriate attachment medium for a heating element, electrical insulation, and a sufficient thermal conductivity to transfer the heat to the thermal distribution layer (e.g., cured rubber, fiberglass weaves, composite adhesives). The thermal distribution layer is made of a material that provides electrical insulation but, at the same time, effectively diffuses and rapidly conducts heat from the heating element to the outer cover layer (e.g., rubber-coated fiberglass fabric). The cover layer is made of a material that has a high thermal conductivity, is resistant to abrasion/corrosion, and is sufficiently stiff/strong for protective purposes (e.g., aluminum alloy, stainless steel).

In operation, the heating element is electrically heated, whereby heat is transmitted to the thermal distribution layer, which uniformly distributes the heat to the outer cover layer to remove accumulated ice therefrom. The purpose of the ice-protection system is to break the adhesion (or boundary layer bond) between the outermost surface and the ice so that the latter will be broken into small pieces, which may be swept away by the airstream passing over the airfoil. In tests performed by the inventor, the bond, or adhesion, reflected a shear strength of about 135 psi for regular finish 2024 Aluminum, about 180 psi for polished 2024 Aluminum, and about 108 psi for stainless steel. (See Appendix A.) In any event, the amount of power required to operate the ice-protection system is directly related to the ice adhesion qualities of the outermost surface.

### SUMMARY OF THE INVENTION

The present invention provides an aircraft ice-protection system, wherein ice adhesion is greatly decreased due to an ice-adhesion-reducing coating thereby translating into lower power requirements.

More particularly, the present invention provides an ice-protection system comprising a heater element, an electrically and thermally insulating medium that at least partially surrounds the heater element, an ice-adhesion-reducing coating, and an outermost surface to which the coating is applied. The coating reduces the ice adhesion of the outermost surface by at least about 30%, at least about 40%, at least about 50%, at least about 60%, at least about 70%, at least about 80%, and/or at least about 85% when compared to an uncoated version of the outermost surface.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIG. 1 is a schematic illustration of an ice-protection system according to the present invention when installed on an aircraft.

FIG. 2 is a plan view of the ice-protection system in a flat condition prior to installation on the aircraft, with certain layers partially removed to show the underlying layer(s).

FIG. 3 is a cross-sectional view of the ice-protection system when installed on the aircraft.

FIG. 4 is a cross-sectional view of an alternate embodiment of the ice protection system.

### DETAILED DESCRIPTION

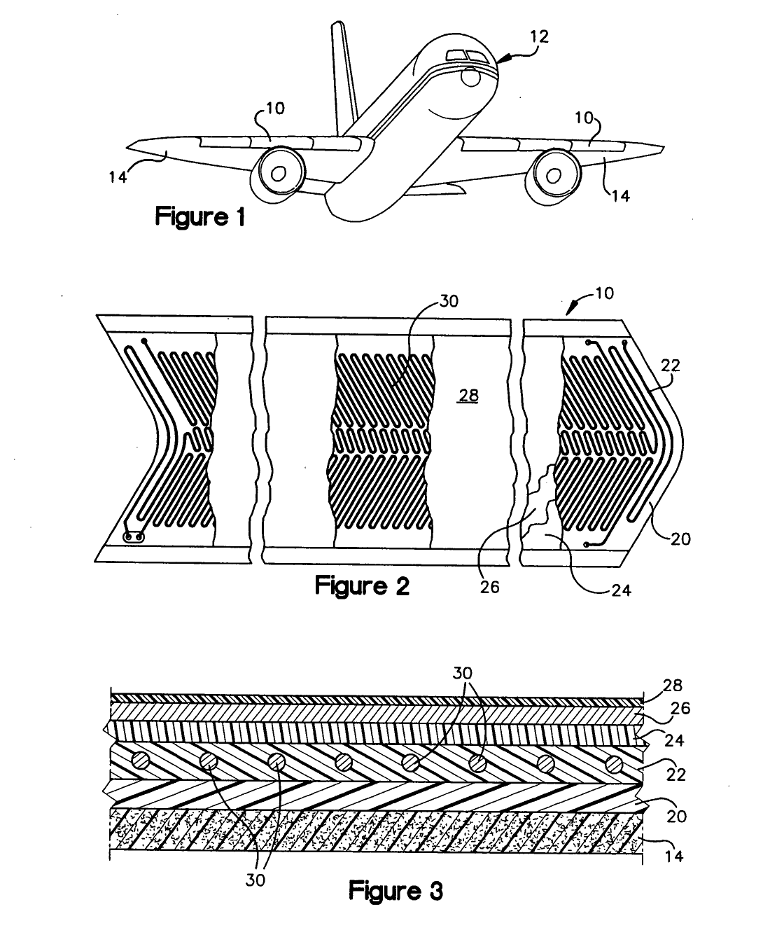

Referring now to the drawings, and initially to FIG. 1, ice-protection systems 10 according to the present invention are shown installed on an aircraft 12. More particularly, an ice-protection system 10 is secured to each of the aircraft's wings 14 to prevent ice accumulation thereon. Modified versions of the systems 10 can be used on other ice-susceptible structural members of the aircraft 12 such as, for example, stabilizers, engine inlets, and/or rotors. Also, the system 10 may find application in non-aircraft situations (e.g., ships, boats, vehicles, etc.) wherein ice prevention and/or elimination is a concern.

Referring now to FIGS. 2 and 3, the ice-protection system 10 is shown in more detail. The illustrated panel 10 comprises an inner support layer 20, a heating layer 22, a thermal distribution layer 24, an outer cover layer 26, and low ice adhesion coating 28. The layers 20, 22, 24, and 26 are bonded together, and the inner support layer 20 is attached (e.g., cemented) to the aircraft wing 14. The heater layer 22 incorporates a heating element 30 which, in operation, is electrically heated, whereby heat is transmitted to the thermal distribution layer 24, which uniformly distributes the heat to the cover layer 26.

The layers 20, 22, 24, and 26 are made of materials that will adhere to each other to provide an integral structure, have a sufficient flexibility for installation but an appropriate stiffness for operation, and maintain their desired properties at a wide range of temperatures in order to accommodate high manufacturing temperatures and low aircraft operating temperatures. Additionally, factors such as cost, ease in manufacture, and weight will be likely considerations in the selection of the layer materials.

The inner support layer 20 is made of a material that provides electrical insulation between the heating elements 30 and the wing 14 (e.g., rubber coated fiberglass fabric). The heater layer 22 is made of a material that provides an appropriate attachment medium for the heating element 30, electrical insulation, and a sufficient thermal conductivity to transfer the heat from the element 30 to the layer 24 (e.g., cured rubber, fiberglass weaves, composite adhesives). The thermal conducting layer 24 is made of a material that provides electrical insulation but, at the same time, effectively diffuses and rapidly conducts heat from the heating element 30 to the outer cover layer 26 (e.g., rubber coated fiberglass fabric). The cover layer 26 is made of a material that has a high thermal conductivity, is resistant to abrasion/corrosion, and is sufficiently stiff/strong for protective purposes (e.g., aluminum, stainless steel). In this embodiment of the invention, the outer surface of the cover layer 26 forms the outermost layer of the panel 10 to which the coating 28 is applied.

In operation, the heating element 30 is electrically heated, whereby heat is transmitted to the thermal distribution layer 24, which uniformly distributes the heat to the cover layer 26. The coating 28 is selected to reduce the ice adhesion of the outermost surface of the cover layer 26. Specifically, the coating 28 reduces the ice adhesion of this surface by at least about 30%, at least about 40%, at least about 50%, at least about 60%, at least about 70%, at least about 80%, and/or at least about 85%, when compared to an analogous uncoated surface. This reduction in ice adhesion translates directly into decreased power requirements.

One coating that has been tested is a coating from the Timken Company of Canton, Ohio (NYSE—TKR) designated or called as “ES600.” Testing results of ES600 have shown a decreased ice adhesion over uncoated aluminum and stainless steel parts. (See Appendix B.) In fact, there was an 87% reduction in ice adhesion on ES600-coated 2024 aluminum and a 65% reduction on stainless steel. Ice adhesion, rain erosion, and icing wind tunnel testing has demonstrated that ES600 is an excellent coating for decreased ice adhesion bond strength and surface wear resistance. (See Appendix C.)

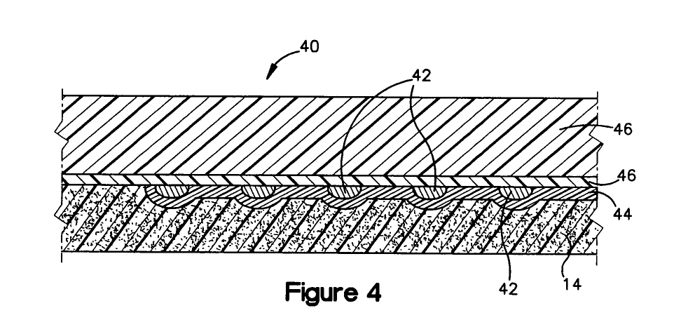

FIG. 4 shows an alternate embodiment of the invention, wherein an ice protection system 40 comprises surface-mounted heating elements 42 and a medium 44 that at least partially surrounds the heating elements 42. In this embodiment, the outer surface of the medium 44 and the exposed outer portions of the heating elements 42 form the outermost surface to which a coating 46 is applied. The coating 46 can be the same as the coating 28, and one or two levels may be used.

Although the invention has been shown and described with respect to a certain preferred embodiment, it is evident that equivalent and obvious alterations and modifications will occur to others skilled in the art upon the reading and understanding of this specification. The present invention includes all such alterations and modifications and is limited only by the scope of the following claims.

1. An ice-protection system comprising a heater element, an electrically insulating and thermally insulating medium which at least partially surrounds the heater element, an ice-adhesion-reducing coating, and an outermost surface to which the coating is applied;
wherein the coating reduces the ice adhesion of the outermost surface by at least about 30% when compared to an uncoated version of the outermost surface.

2. An ice-protection system as set forth in claim 1, wherein the coating reduces the ice adhesion of the outermost surface by at least about 40% when compared to an uncoated version of the outermost surface.

3. An ice-protection system as set forth in claim 2, wherein the coating reduces the ice adhesion of the outermost surface by at least about 50% when compared to an uncoated version of the outermost surface.

4. An ice-protection system as set forth in claim 3, wherein the coating reduces the ice adhesion of the outermost surface by at least about 60% when compared to an uncoated version of the outermost surface.

5. An ice-protection system as set forth in claim 4, wherein the coating reduces the ice adhesion of the outermost surface by at least about 70% when compared to an uncoated version of the outermost surface.

6. An ice-protection system as set forth in claim 5, wherein the coating reduces the ice adhesion of the outermost surface by at least about 80% when compared to an uncoated version of the outermost surface.

7. An ice-protection system as set forth in claim 8, wherein the coating reduces the ice adhesion of the outermost surface by at least about 85% when compared to an uncoated version of the outermost surface.

8. An ice-protection system as set forth in claim 1, wherein the outermost surface is formed by the outer surface of an aluminum layer.

9. An ice-protection system as set forth in claim 1, wherein the outermost surface is formed by the outer surface of a stainless steel layer.

10. An ice-protection system as set forth in claim 1, wherein the outermost surface is formed by exposed portions of a heating element and/or the outermost surface of a medium surrounding the heating element.

11. In combination, an aircraft and an ice-protection system as set forth in claim 1, the system being secured to an ice-susceptible member of the aircraft.

12. A combination as set forth in claim 11, wherein the ice-susceptible member is a wing of the aircraft.

13. In combination, an aircraft and a pair of ice-protection systems as set forth in claim 1, one of the systems being secured to each wing of the aircraft.
